(19) United States
(12) Patent Application Publication
(10) Pub. No.: US 2025/0378444 A1
(43) Pub. Date: Dec. 11, 2025

(54) DATA CLASSIFICATION FOR FRAUD DETECTION

(71) Applicant: Wells Fargo Bank, N.A., San Francisco, CA (US)

(72) Inventors: Hari Prasada Raju Kunadharaju, Hyderabad (IN); Jagadeesh Ganaparthi, Hyderabad (IN)

(21) Appl. No.: 18/739,845

(22) Filed: Jun. 11, 2024

(51) Int. Cl. G06Q 20/40; G06Q 40/02

(52) U.S. Cl. CPC G06Q 20/4016; G06Q 40/02

(57) ABSTRACT

A computer system for classifying financial data as fraudulent can include: one or more processors; and non-transitory computer-readable storage media encoding instructions which, when executed by the one or more processors, causes the computer system to: receive a financial data set associated with an organization; automatically select optimal attributes of the financial data set using an optimization algorithm to extract optimal features required to classify the financial data set; dynamically determine a number of layers of a fraud detection model while training the fraud detection model with the financial data set and the optimal features; and classify the financial data set to indicate fraud by executing the fraud detection model in the number of layers using the optimal features.

### BACKGROUND

Organizations communicate financial statuses to stakeholders, regulatory authorities, and other financial institutes through financial statements and other associated data. Financial statements are tools for investors to determine the feasibility of investing in an organization. Additionally, government agencies use financial statements to collect taxes and provide financial aid.

Sometimes, organizations with significant losses provide misleading financial statements to attract investments and increase stock prices. Further, organizations can obtain loans with false financial statements and later fail to repay, causing global repercussions due to financial fraud. Fraudulent financial statements can also be used to reduce tax liabilities and gain other benefits.

Current financial fraud detection processes are often based on predefined attributes or rules and can be susceptible to manipulation by fraudsters. Further, dealing with imbalanced datasets and missing values can lead to inaccurate and unreliable results.

### SUMMARY

Examples provided herein are directed to data classification for fraud detection.

According to one aspect, an example computer system for classifying financial data as fraudulent can include: one or more processors; and non-transitory computer-readable storage media encoding instructions which, when executed by the one or more processors, causes the computer system to: receive a financial data set associated with an organization; automatically select optimal attributes of the financial data set using an optimization algorithm to extract optimal features required to classify the financial data set; dynamically determine a number of layers of a fraud detection model while training the fraud detection model with the financial data set and the optimal features; and classify the financial data set to indicate fraud by executing the fraud detection model in the number of layers using the optimal features.

According to another aspect, an example method for classifying financial data as fraudulent can include: receiving a financial data set associated with an organization; automatically selecting optimal attributes of the financial data set using an optimization algorithm to extract optimal features required to classify the financial data set; dynamically determining a number of layers of a fraud detection model while training the fraud detection model with the financial data set and the optimal features; and classifying the financial data set to indicate fraud by executing the fraud detection model in the number of layers using the optimal features.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system for data classification for fraud detection.

FIG. 2 shows example logical components of a server device of the system of FIG. 1.

FIG. 3 shows an example method as executed by the server device of FIG. 2.

FIG. 4 shows example physical components of the server device of FIG. 2.

### DETAILED DESCRIPTION

This disclosure relates to data classification for fraud detection.

In the examples provided herein, data classification is performed by automatically selecting optimal attributes from a financial dataset. These optimal attributes can then be leveraged to dynamically determine aspects of a fraud detection model used to classify the financial data. This classify of an organization's financial data is used to detect fraud, such as discrepancies in the organization's financial statements.

More specifically, the example concept involves receiving a financial data set associated with an organization, where the financial data set comprises the organization's financial statements, balance sheets, income/profit/loss statements, and the like. Optimal attributes of the financial data set are automatically selected using one or more optimization algorithms to extract one or more optimal features required to classify the financial data. The optimal attributes are the variables or data fields of the financial data, and the optimal features are the predictors associated with the classification of financial data. The number of layers of a fraud detection model can be dynamically determined while training the fraud detection model with the financial data set and the optimal features. Finally, the financial data set can be classified into various categories, such as good, manipulated, and bad, by executing the fraud detection model in the determined layers using the optimal features.

There can be various advantages associated with the technologies described herein. For instance, the data classifications described herein solve the technical problem of the identification of fraud. Further, the dynamic determination of the optimal attributes for training of the model results in the practical application of a model that is better tuned for the efficient identification of fraudulent activity.

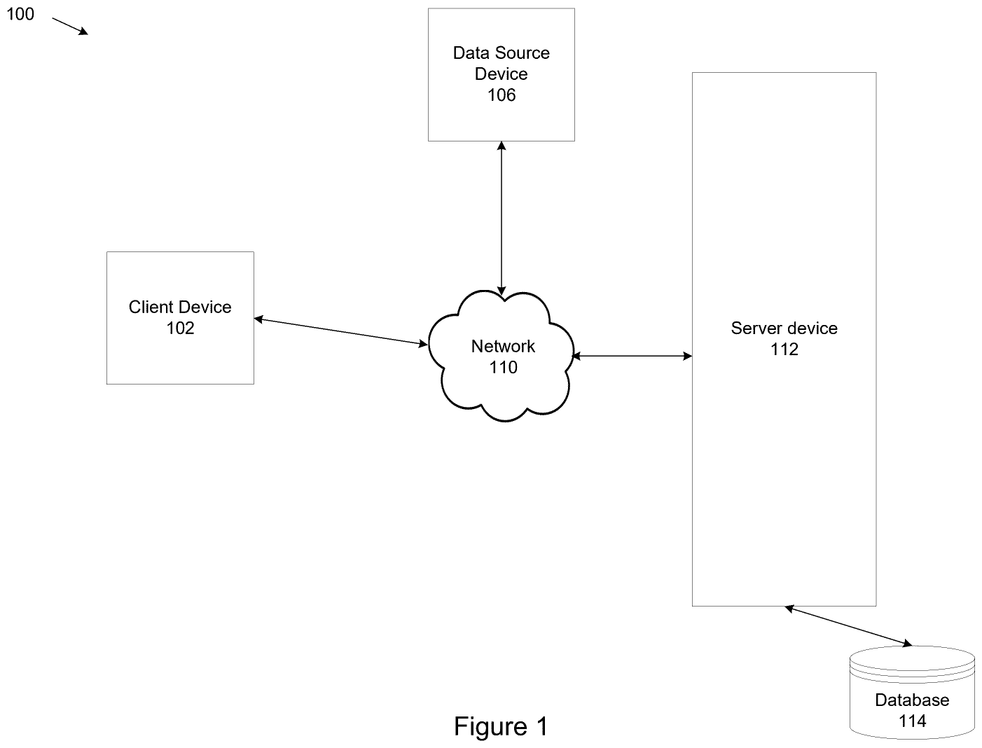

FIG. 1 schematically shows aspects of one example system 100 programmed to classify data for fraud detection. In this example, the system 100 can be a computing environment that includes a plurality of client and server devices. In this instance, the system 100 includes client device 102, a data source device 106, a server device 112, and a database 114. The client device 102 and the data source device 106 can communicate with the server device 112 through a network 110 to accomplish the functionality described herein.

Each of the devices may be implemented as one or more computing devices with at least one processor and memory. Example computing devices include a mobile computer, a desktop computer, a server computer, or other computing device or devices such as a server farm or cloud computing used to generate or receive data.

In some non-limiting examples, the server device 112 is owned by a financial institution, such as a bank. The client device 102 and the data source device 106 can be programmed to communicate with the server device 112 to classify data for fraud detection. Many other configurations are possible.

The example client device 102 is programmed to initiate and control the classification of a financial data set to make a fraud determination. For example, the client device 102 can communicate with the data source device 106 and the server device 112 to implement the concepts provided herein.

The example data source device 106 is programmed to provide the financial data sets upon which the classification is conducted. In some examples, the data source device 106 may house various financial data associated with an organization, such as the organization's financial statements, balance sheets, income/profit/loss statements, and the like. When queried by the client device 102 and/or the server device 112, the data source device 106 can provide this financial data set to the server device 112 for analysis. In alternative embodiments, the financial data set for the organization can be provided in different ways or the server device 112 may already have the financial data set.

The example server device 112 is programmed to receive the financial data set from the data source device 106, classify the financial data set, and make a fraud determination. Additional details on the functionality of the server device 112 is provided below.

The example database 114 is programmed to store data that is accessed by the server device 112. For instance, the database 114 can store the financial data set from the data source device 106, the classification and modeling of the financial data set, and the fraud determination. Many configurations are possible.

The network 110 provides a wired and/or wireless connection between the client devices 102, 106 and the server device 112. In some examples, the network 110 can be a local area network, a wide area network, the Internet, or a mixture thereof. Many different communication protocols can be used. Although only three devices are shown, the system 100 can accommodate hundreds, thousands, or more of computing devices.

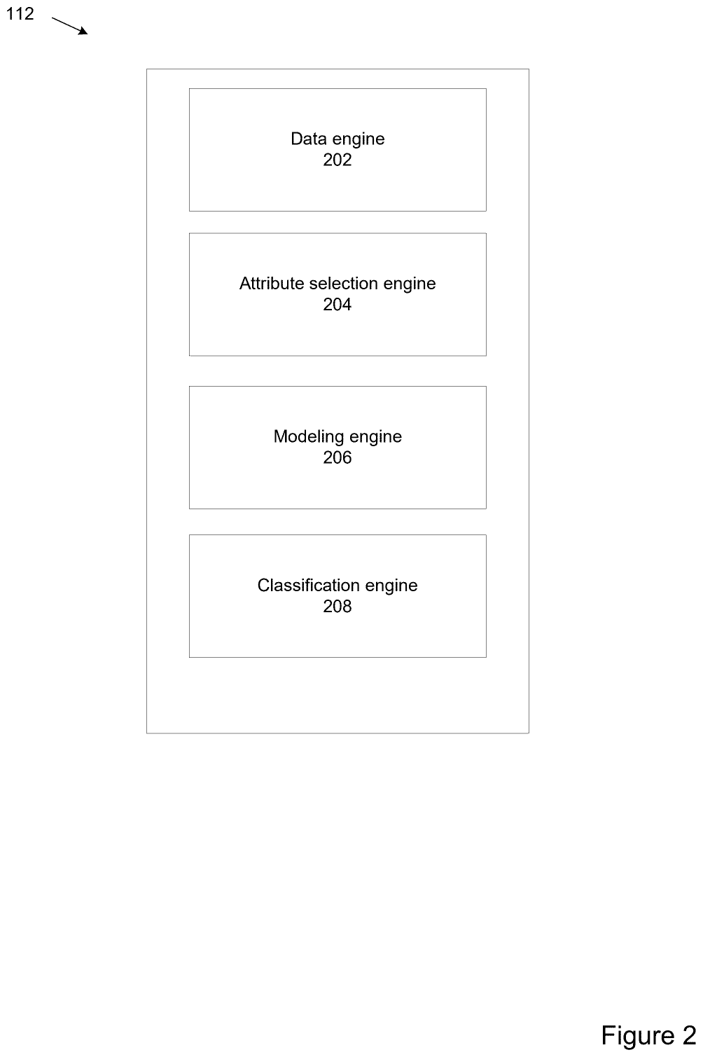

Referring now to FIG. 2, additional details of the server device 112 are shown. In this example, the server device 112 has various logical engines that assist in the classification of the financial data to make the fraud determination. The server device 112 can, in this instance, include a data engine 202, an attribute selection engine 204, a modeling engine 206, and a classification engine 208. In other examples, more or fewer engines providing different functionality can be used.

The example data engine 202 is programmed to receive the financial data set associated with the organization. As previously noted, the financial data set can include financial statements, data/reports related to the organization's financial performance, and the like. For example, the financial data set includes data/reports used by the organization during the Initial Public Offering (IPO) filing or for receiving financial help from financial institutions. The data engine 202 can store the financial data set in the database 114.

The example attribute selection engine 204 is programmed to select optimal attributes of the financial data set using one or more optimization algorithms. The optimal attributes are the data variables or fields, and the optimal features are the predictors associated with the financial dataset of the organization. A few such examples are, without limitation: year, company, category, market cap, revenue, gross profit, net income, earnings per share, earnings before interest, taxes, depreciation, and amortization (EBITDA), shareholder equity, cashflow from operating, cashflow from investing, return on equity (ROE), return on assets (ROA), return on investment (ROI), and debt equity ratio. Predictors may assist in the classification of the financial data. In one example, the system extracts the global minimum optimal features required to classify the financial data set.

The optimal attributes may differ for each organization based upon differences such as the industry (e.g., medical versus automotive), size (e.g., large cap versus small cap), and location (e.g., US versus Europe). In one example, the attribute selection engine 204 can use a Particle Swarm Optimization (PSO) algorithm to select the optimal attributes, extracting one or more optimal features required to classify the financial data. In this example, the PSO is a computational method that finds the optimal attributes through iteratively attempting to improve the solution.

The example modeling engine 206 is programmed to dynamically determine an optimal number of layers of a fraud detection model while training the model. The fraud detection model may be trained using the optimal features to detect fraud in the organization's financial statements.

For instance, the modeling engine 206 tunes the fraud detection model while training by dynamically changing the number of layers of the model, thereby enhancing the efficiency of the model. This tuning can be based upon various factors, such as the volume and quality of the financial data set. Each output can be compared to known inputs (e.g., known good or bad statements) by the modeling engine 206 to determine if classification by the fraud detection model is accurate and thereby select the optimal number of layers. This feedback loop allows the modeling engine 206 to dynamically define the proper number of layers.

The fraud detection model may use a residual neural network-based classification model to classify the financial dataset of the organization, such as a ResNet-50 architecture or another type of convolutional neural network. For example, the number of layers of the residual neural network may be determined by the modeling engine 206, rather than being preset. In one instance, the modeling engine 206 can determine an optimal number of 55 layers, with 52 convolutional layers, 2 MaxPool layers, and one average pool layer.

As a more specific example, the modeling engine 206 can calculate the optimal number of layers dynamically as follows.
Existing: ResNet-50 is a 50-layer convolutional neural network (48 convolutional layers, one MaxPool layer, and one average pool layer)
Proposed: ResNet-55 is a 55-layer convolutional neural network (52 convolutional layers, two MaxPool layer, one average pool layer)

The accuracy of fraud detection model is higher when a loss value is smaller. In this instance, the training loss value of the ResNet-50 model is 0.0033 and the validation loss value is 0.0123, whereas the proposed ResNet-55 model further reduces the loss and is therefore more efficient.

The example classification engine 208 is programmed to classify the financial data set of the organization to detect fraudulent financial statements. For instance, the classification engine 208 executes the fraud detection model with the determined number of layers using the extracted optimal features. The classification engine 208 then classifies the financial data set into various buckets, such as good, manipulated, and bad. The ‘good’ bucket indicates the trusted and authentic data of the financial statements, whereas the ‘manipulated/bad’ buckets indicate the fraudulent financial data manipulated and presented by the organization.

Once the classification engine 208 finishes the classification, an accuracy level is determined, along with a sensitivity level. The accuracy and sensitivity levels are used to finetune future iterations of fraud detection by the system 100. Many other configurations are possible.

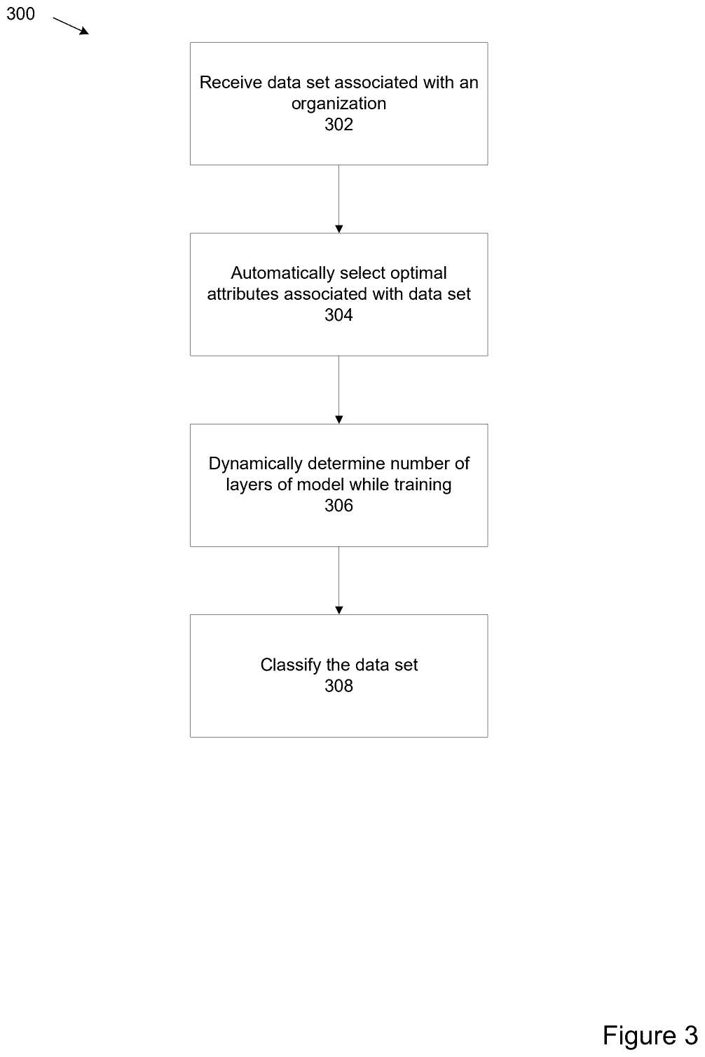

Referring now to FIG. 3, an example method 300 for classifying data for fraud detection is shown. This method 300 can be executed by the system 100.

At operation 302 of the method 300, the financial data set is received. As noted, this can come from various sources, such as the organization and/or a third party, or the system 100 may already have the financial data set.

Next, at operation 304, the optimal attributes associated with the financial data set are automatically selected. This can be accomplished using the PSO algorithm to select the optimal attributes. At operation 306, the number of layers for the model are dynamically determined during training.

Finally, at operation 308, the financial data set is classified using the model. This classification can be used to indicate whether the financial data set is good or fraudulent.

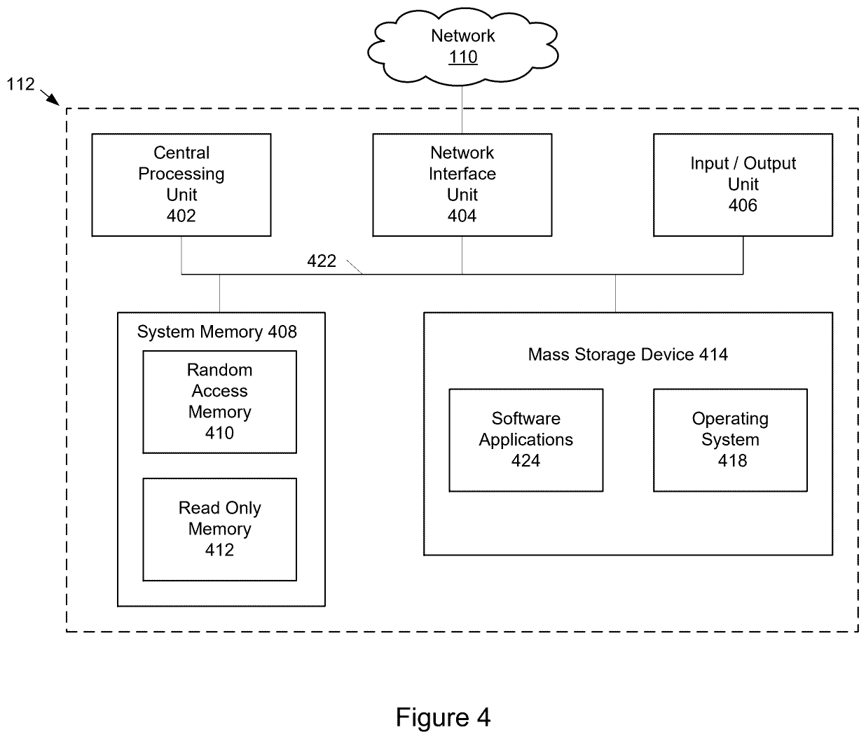

As illustrated in the embodiment of FIG. 4, the example server device 112, which provides the functionality described herein, can include at least one central processing unit (“CPU”) 402, a system memory 408, and a system bus 422 that couples the system memory 408 to the CPU 402. The system memory 408 includes a random access memory (“RAM”) 410 and a read-only memory (“ROM”) 412. A basic input/output system containing the basic routines that help transfer information between elements within the server device 112, such as during startup, is stored in the ROM 412. The server device 112 further includes a mass storage device 414. The mass storage device 414 can store software instructions and data. A central processing unit, system memory, and mass storage device similar to that shown can also be included in the other computing devices disclosed herein.

The mass storage device 414 is connected to the CPU 402 through a mass storage controller (not shown) connected to the system bus 422. The mass storage device 414 and its associated computer-readable data storage media provide non-volatile, non-transitory storage for the server device 112. Although the description of computer-readable data storage media contained herein refers to a mass storage device, such as a hard disk or solid-state disk, it should be appreciated by those skilled in the art that computer-readable data storage media can be any available non-transitory, physical device, or article of manufacture from which the central display station can read data and/or instructions.

Computer-readable data storage media include volatile and non-volatile, removable, and non-removable media implemented in any method or technology for storage of information such as computer-readable software instructions, data structures, program modules, or other data. Example types of computer-readable data storage media include, but are not limited to, RAM, ROM, EPROM, EEPROM, flash memory or other solid-state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the server device 112.

According to various embodiments of the invention, the server device 112 may operate in a networked environment using logical connections to remote network devices through network 110, such as a wireless network, the Internet, or another type of network. The server device 112 may connect to network 110 through a network interface unit 404 connected to the system bus 422. It should be appreciated that the network interface unit 404 may also be utilized to connect to other types of networks and remote computing systems. The server device 112 also includes an input/output controller 406 for receiving and processing input from a number of other devices, including a touch user interface display screen or another type of input device. Similarly, the input/output controller 406 may provide output to a touch user interface display screen or other output devices.

As mentioned briefly above, the mass storage device 414 and the RAM 410 of the server device 112 can store software instructions and data. The software instructions include an operating system 418 suitable for controlling the operation of the server device 112. The mass storage device 414 and/or the RAM 410 also store software instructions and applications 424, that when executed by the CPU 402, cause the server device 112 to provide the functionality of the server device 112 discussed in this document.

Although various embodiments are described herein, those of ordinary skill in the art will understand that many modifications may be made thereto within the scope of the present disclosure. Accordingly, it is not intended that the scope of the disclosure in any way be limited by the examples provided.

1. A computer system for classifying financial data as fraudulent, comprising:
one or more processors; and
non-transitory computer-readable storage media encoding instructions which, when executed by the one or more processors, causes the computer system to:
generate a fraud detection model, the fraud detection model including a first number of layers;
receive a financial data set associated with an organization;
automatically select optimal attributes of the financial data set using an optimization algorithm to extract optimal features required to classify the financial data set;
dynamically change, based on a volume of data of the financial data set, the first number of layers of the fraud detection model to a second number of layers of the fraud detection model while training the fraud detection model with the financial data set and the optimal features, using a feedback loop to enhance efficiency of the fraud detection model, wherein the feedback loop is configured to iteratively compare outputs to inputs comprising known good or bad statements to determine when classification by the fraud detection model provides a desired level of accuracy as measured by a training loss value and a validation loss value, with the training loss value providing a difference between model predictions and actual data labels, and the validation loss value that measures performance of the fraud detection model on validation data not used for training, and wherein the fraud detection model comprises a multi-layer neural network architecture with multiple convolutional layers for feature extraction and pattern recognition, at least one pooling layer for dimensionality reduction and feature aggregation, and at least one average pooling layer for spatial averaging and feature summarization; and
classify the financial data set to indicate fraud by executing the fraud detection model in the second number of layers using the optimal features.

2. The computer system of claim 1, wherein the financial data set includes financial statements, balance sheets, and income/profit/loss statements associated with the organization.

3. The computer system of claim 1, wherein the optimal attributes are variables associated with the financial data set.

4. The computer system of claim 3, wherein the optimal features are predictors associated with classification of the financial data set.

5. The computer system of claim 1, comprising further instructions which, when executed by the one or more processors, causes the computer system to classify the financial data set into good, manipulated, and bad buckets.

6. The computer system of claim 1, wherein the optimization algorithm is a Particle Swarm Optimization algorithm.

7-10. (canceled)

11. A method for classifying financial data as fraudulent, comprising:
generating a fraud detection model, the fraud detection model including a first number of layers;
receiving a financial data set associated with an organization;
automatically selecting optimal attributes of the financial data set using an optimization algorithm to extract optimal features required to classify the financial data set;
dynamically changing, based on a volume of data of the financial data set, the first number of layers of the fraud detection model while training the fraud detection model with the financial data set and the optimal features, using a feedback loop to enhance efficiency of the fraud detection model, wherein the feedback loop is configured to iteratively compare outputs to inputs comprising known good or bad statements to determine when classification by the fraud detection model provides a desired level of accuracy as measured by a training loss value and a validation loss value, with the training loss value providing a difference between model predictions and actual data labels, and the validation loss value that measures performance of the fraud detection model on validation data not used for training, and wherein the fraud detection model comprises a multi-layer neural network architecture with multiple convolutional layers for feature extraction and pattern recognition, at least one pooling layer for dimensionality reduction and feature aggregation, and at least one average pooling layer for spatial averaging and feature summarization; and
classifying the financial data set to indicate fraud by executing the fraud detection model in the second number of layers using the optimal features.

12. The method of claim 11, wherein the financial data set includes financial statements, balance sheets, and income/profit/loss statements associated with the organization.

13. The method of claim 11, wherein the optimal attributes are variables associated with the financial data set.

14. The method of claim 13, wherein the optimal features are predictors associated with classification of the financial data set.

15. The method of claim 11, further comprising classifying the financial data set into good, manipulated, and bad buckets.

16. The method of claim 11, wherein the optimization algorithm is a Particle Swarm Optimization algorithm.

17-20. (canceled)
